(19) United States
(12) Patent Application Publication
(10) Pub. No.: US 2007/0114279 A1
(43) Pub. Date: May 24, 2007

(54) SYSTEM AND METHOD FOR CAPTURING AND STORING RFID/SERIALIZED ITEM TRACKING INFORMATION IN A RELATIONAL DATABASE SYSTEM

(76) Inventors: Pieter Lessing, Los Angeles, CA (US); Dennis Jeng, Yorba Linda, CA (US); Mark Crosby, Venice, CA (US); Sreedhar Srikant, Lexington, KY (US)

Correspondence Address: James M. Stover;Intellectual Property Section , Law Department, NCR Corporation, 1700 South Patterson Blvd., Dayton, OH, 45479-0001, US

(21) Appl. No.: 11/469,510

(22) Filed: Sep. 1, 2006

Related U.S. Application Data
(60) Provisional application No. 60/713,385, filed on Sep. 1, 2005.

(51) Int. Cl. G06Q 30/00; G07B 15/02; G06Q 20/00

(52) U.S. Cl. 235/385; 235/384; 705/22

(57) ABSTRACT

A computer implemented method of and system for capturing, storing and organizing serialized tracking information associated with products sold by a retail enterprise. The serialized tracking information, available through the use of RFID technology, is stored and organized within a relational database in accordance with a logical data model comprising a plurality of entities and relationships defining the manner in which serialized item tracking information associated is stored and organized within the relational database. The relational database, populated with serialized tracking information, provides the retail enterprise with the means to analyze and improve supply chain operations, to better manage store inventory, and more efficiently manage product sales and returns.

### CROSS REFERENCE TO RELATED APPLICATIONS

This application claims priority under 35 U.S.C. § 19(e) to the following co-pending and commonly-assigned patent applications, which are incorporated herein by reference:

Provisional Application Ser. No. 60/713,385, entitled “RFID/SERIALIZED ITEM TRACKING IN A RELATIONAL DATABASE SYSTEM,” filed on Sep. 1, 2005, attorney's docket number 12221.

This application is related to the following co-pending and commonly-assigned patent applications, which are incorporated by reference herein:

Application Ser. No. 10/016,899, entitled “SYSTEM AND METHOD FOR CAPTURING AND STORING INFORMATION CONCERNING SHOPPERS INTERACTIONS AND TRANSACTIONS WITH AN E-BUSINESS RETAILER”, filed on Dec. 14, 2001, by Kim Nguyen-Hargett and Pieter Lessing; NCR Docket Number 9856;

Application Ser. No. 10/017,146, entitled “SYSTEM AND METHOD FOR CAPTURING AND STORING INFORMATION CONCERNING RETAIL STORE OPERATIONS,” filed Dec. 14, 2001, by Kim Nguyen-Hargett and Pieter Lessing; NCR Docket Number 9858; and

Application Ser. No. 10/190,099, entitled “SYSTEM AND METHOD FOR CAPTURING AND STORING FINANCIAL MANAGEMENT INFORMATION,” filed on Jul. 3, 2002 by Sreedhar Srikant, William S. Black, Scott Kilmo, Karen Papierniak and James W. Smith; attorney's docket number 10145.

### FIELD OF THE INVENTION

The present invention relates generally to Data Warehouse solutions, and more particularly, to systems and methods for capturing, storing and using detailed data on store operations for a Retail Business. Still more particularly, the present invention is related to a logical data model for storing and organizing RFID/serialized tracking information within a Retail Business data warehouse system.

### BACKGROUND OF THE INVENTION

Manufacturers, distributors and retailers are increasingly utilizing RFID (Radio Frequency Identification) technology to uniquely identify and track products. In the retail environment RFID technology is currently being adopted, prototyped and deployed in a limited fashion at various product levels, e.g., pallet, case, inner pack, or each, by various leading retailers worldwide. A primary interest of retailers in applying RFID technology is in increasing the supply chain efficiency at their distribution centers, as well as the efficiency of transportation to stores and store activities. A secondary interest is in tracking and tracing of RF-tagged products on the demand side from the time products are removed from the store shelf for purchase until they are scanned and purchased at a point-of-sale (POS) terminal.

NCR Corporation has developed a data warehouse solution including a comprehensive suite of analytical and operational applications that captures, organizes and advances the use of high-value business information within a Retail Business. An objective of NCR Corporation's retail data warehouse solution is to enable retail management to easily access and analyze information that is critical to the operation of retail outlets. The addition of serialized tracking information, available through the use of RFID technology, to a retail data warehouse solution provides a retailer with the means to analyze and improve supply chain operations, to better manage store inventory, and more efficiently manage product sales and returns.

### BRIEF DESCRIPTION OF THE DRAWINGS

The present invention is illustrated by way of example, and not by limitation, in the Figures of the accompanying drawings, wherein elements having the same reference numeral designations represent like elements throughout and wherein:

FIG. 1 provides an overview of the hardware components of a data warehouse system;

FIG. 2 is a high level illustration of the Teradata Solutions for Retail data warehouse solution and included analytical and operational applications in accordance with the present invention;

FIGS. 3A through 3C, taken together, provide a conceptual data model view of a retail industry logical data model (retail LDM) illustrating the most important entities in the retail LDM and how they generally relate to each other, in accordance with the preferred embodiment of the present invention; and

FIGS. 4A through 4E illustrate an entity-relationship diagram of the RFID/SERIALIZED TRACKING subject area of the logical data model in accordance with the preferred embodiment of the present invention.

### BEST MODE FOR CARRYING OUT THE INVENTION

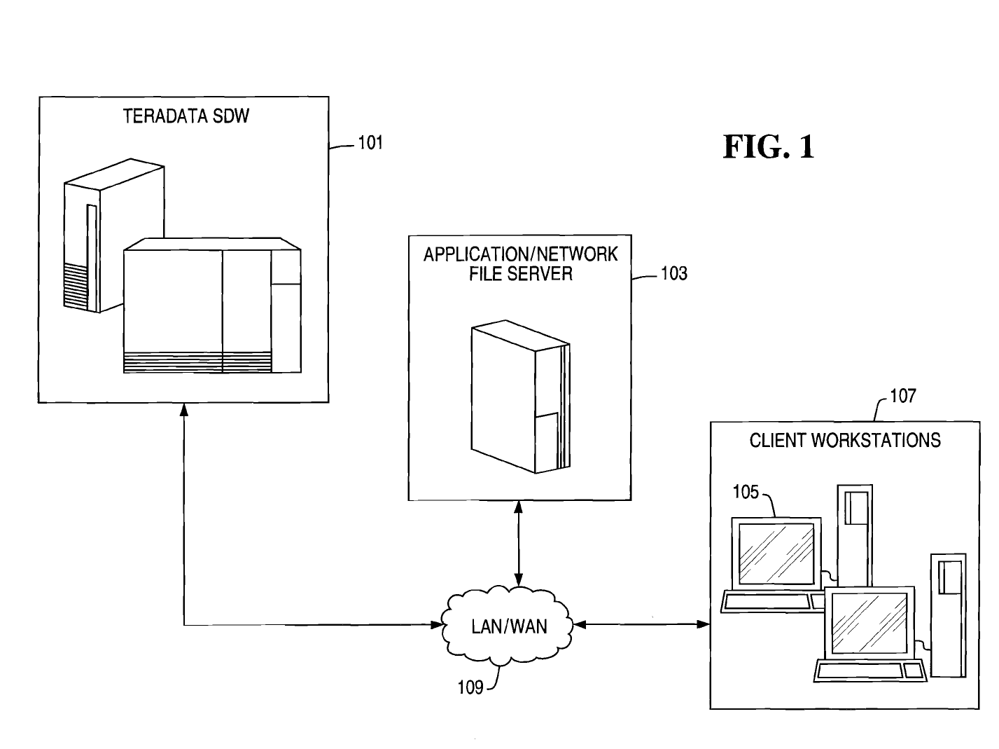

FIG. 1 provides an overview of the hardware required for a data warehouse solution. The basic components consist of an NCR Corporation Teradata Scalable Data Warehouse 101, an administrative server 103, and client and administrative workstations 105 and 107, respectively. The components communicate with each other through a Local Area Network (LAN) or Wide Area Network (WAN), identified by reference numeral 109.

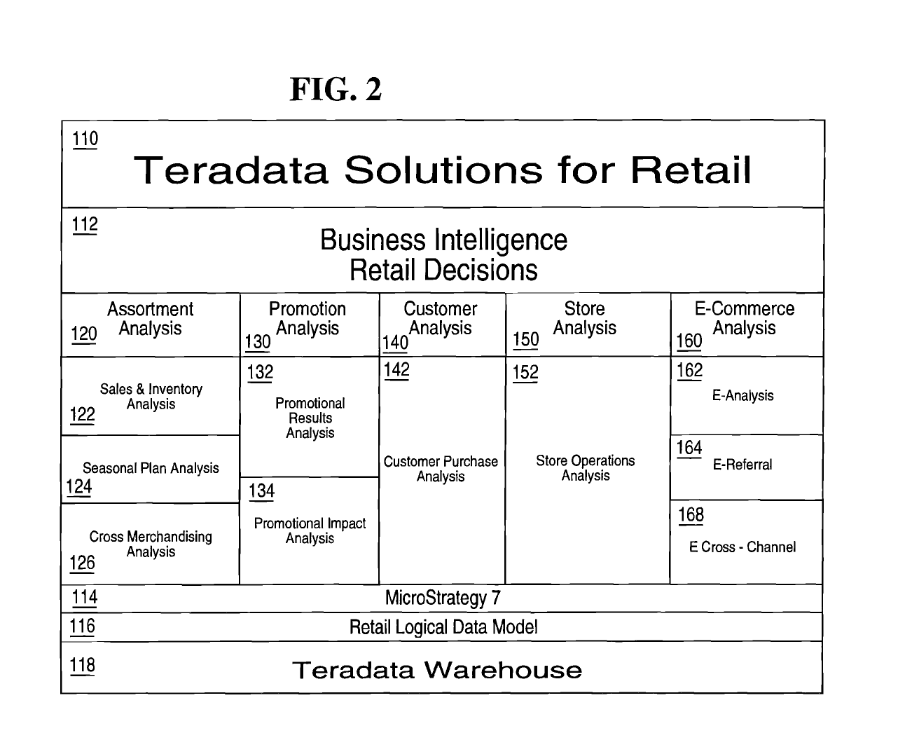

A retail business customer-centric warehouse is established on the Teradata Scalable Data Warehouse 101 as defined by the Retail Logical Data Model, described below. The application server 103 supports retail analytic and operational applications, such as NCR Corporation's Teradata Solutions for Retail suite of retail business applications, illustrated in FIG. 2.

The Teradata Solutions for Retail suite of retail business applications comprises several analytic applications built on a common data model 116, leveraging a single source of data 118 across all departments. The application suite includes the following application members: Assortment Analysis 120, Promotion Analysis 130, Customer Analysis 140, Store Analysis 150 and E-Commerce Analysis 160.

Assortment Analysis (120). The Assortment Analysis application is the foundation for basic sales and inventory reporting; monitoring of sales trends by geography, product and product trait. Beyond basic reporting, functionality includes assortment planning and allocation analysis; additional view of seasonal planning and additional detail on vendor performance measures. Also provides advanced analysis of assortment based on customer segment preferences using analysis of market basket and customer data.

Assortment Analysis integrates planning processes that occur before and during the selling season resulting in tailored merchandise assortment, pricing and promotional support for unique markets and individual stores. The Assortment Management Analysis provides a diverse set of business analyses and reports (views) that will assist a merchant in arriving at better informed decisions regarding the management of his/her product assortments to the store level.

The Assortment Analysis application consists of three application modules:
1. Sales and Inventory Analysis 122: Elementary foundation for sales and inventory analysis reporting; monitoring of sales trends by geography, product and product trait. The Sales and Inventory Analysis provides performance and contribution reporting; analysis of sales, margin and inventory trends; and sales and inventory exception reporting.
2. Seasonal Plan Analysis 124: Analytical support for assortment planning and allocation analysis, added views on seasonal planning and vendor performance measures. The Seasonal Plan Analysis application module provides analysis and metrics concerning: store/area/department performance; item and category contribution; exception monitoring; and days-of-supply and out of stock.
3. Cross Merchandising Analysis 126: Advanced strategic analysis of assortment based on customer segment preferences using analysis of market basket and customer data. The Seasonal Plan Analysis application module provides analysis and metrics concerning: merchandising mix (Item Affinity); customer purchasing behavior (Customer Preferences); product assortment segmentation; and product introductions and deletions tailored to local market requirements.

Promotion Analysis (130). The Promotional Analysis application enables a retailer to analyze “Lift” by product, brand, or vendor, inventory effectiveness, Seasonal/Regional Demand Patterns and Price Point Analysis.

The Promotion Analysis application is designed to more effectively analyze, plan and target your promotions based on item, store and customer data. By allowing for key sales and inventory performance measurements such as “sell thru”, ending on hand stock, and sales to be combined and presented over various dimensional perspectives, one is provided with more accurate information regarding a promotion's effectiveness.

The Promotion Analysis application consists of two application modules:
1. Promotional Results Analysis application module 132 provides analysis of promotional lift by product, brand, or vendor. The Promotional Results Analysis application module provides analysis and metrics concerning: promotional performance of individual products; promotional inventory level effectiveness; stock levels during promotional periods by store; regional or seasonal demand patterns; unusual sales patterns by store; analysis of ‘forward buying’ phenomena; and the impact of promotions on price point strategies
2. Promotional Impact Analysis application module 134 provides advanced analysis of promotional effectiveness as it relates to product driver relationships and product affinities. The Promotional Impact Analysis application module 134 provides analysis and metrics concerning: market basket: time of day behavior differences (day part tracking); and customer product preferences.

Customer Analysis (140). The Customer Analysis application provides critical insight into a retailer's customer base via ranking, deciling, RFM analysis, demographic segmentation, and defining purchase behavior.

The Customer Analysis application consists of a Customer Purchase Analysis application module 142 that provides critical insight into customer base via ranking, deciling, RFM analysis, demographic segmentation, and defining purchase behavior. The Customer Purchase Analysis application module provides analysis and information concerning: targeted customer promotions; optimum promotional item assortment; promotional effectiveness; and enhanced cross merchandising strategies.

Store Analysis (150). The Store Analysis application provides analysis of store sales, labor, controllable expenses and variances.

The Store Analysis application consists of a Store Operations Analysis application module 152 that provides analysis of store sales, labor, controllable expenses and variances so as to provide a deeper understanding of costs, resources, traffic and productivity. The Store Operations Analysis application module provides analysis and information concerning: location sales; labor allocation policies; variable cost control; and resource (time) allocation.

E-Commerce Analysis (160). The E-Commerce Analysis application provides analysis of customer interactions, ad effectiveness, preference profiling, and cross-channel effectiveness.

The E-Commerce Analysis application provides a better understanding of the customer and their interaction with the e-Storefront: including customer, purchase, promotion, and media analysis. The E-Commerce Analysis application consists of three application modules:
1. E-Analysis application module 162 provides a detailed understanding of customer and e-storefront interaction, product and promotional effectiveness, as well as abandonment and fulfillment analysis. The E-Analysis application module provides analysis and metrics concerning: customer acquisition and retention; customer mix and conversation; marketing promotional effectiveness; and merchandising effectiveness.
2. E-Cross Channel application module 164 provides detailed understanding of customer behavior and interactions, product and promotional impact and contribution across customer contact channels. The E-Cross Channel application module provides analysis and metrics concerning: cross-channel customer management; and customer conversion.
3. E-Referral application module 168 provides detailed understanding of e-storefront interaction and referral effectiveness including referral return on investment (ROI). The E-Analysis application module provides analysis and metrics concerning: advertising media mix optimization; media costs; customer mix; and marketing promotional effectiveness.

### Logical Data Model Design Basics

A logical data model is a graphical representation of the way data is organized in a data warehouse environment. The logical data model specifically defines which individual data elements can be stored and how they relate to one another to provide a model of the business information. The data model ultimately defines which business questions can be answered from the data warehouse and thus determines the business value of the entire decision support system.

A properly designed LDM for a retail industry provides a foundation for more effective sales, marketing, and operations management and supports the customer relationship management (CRM) requirements related to identifying, acquiring, retaining and growing valuable customers. A logical data model for the retail industry reflects the operating principles and policies of the retail industry and provides the underlying structure for the data imported into the data warehouse

A logical data model provides an architecture for the information that will be included in a data warehouse. The database provides the physical realization of that architecture in a form that can be efficiently maintained and used. There may well be some differences between the logical data model and the final database design. The database may include some tables (summary tables, etc.) or columns that have no direct correlation in the logical data model. Elements in the logical model may be grouped differently in the physical database.

A logical data model is organized by Subject Areas, each comprised of numerous Entities, Attributes and Relationships. The data model hierarchy includes one or more Subject Areas. Each Subject Area includes one or more Entities or Tables, each having Attributes and Relationships. Each Attribute describes a fact about an Entity. Relationships between two or more Entities are further defined by Cardinality. The Relationships define which entities are connected to other entities and the cardinality of the relationships. Each of these elements will be described in greater detail below.

### Subject Area

A subject area is a subset of objects taken from the universe of data objects for a particular line of business or industry that focus on a particular Business Process. Typically, a subject area is created to help manage large data architectures that may encompass multiple business processes or business subjects. This is the highest-level data concept within a conceptual entity/relationship (E/R) model. Working with subject areas is especially useful when designing and maintaining a large or complex data model. Dividing the enterprise into several distinct subject areas allows different groups within an organization to concentrate on the processes and functions pertinent to their business area.

### Entity

An Entity represents a person, place, thing, concept, or event (e.g. PARTY, ACCOUNT, INVOICE, etc.). It represents something for which the business has the means and the will to collect and store data. An Entity must have distinguishable occurrences, e.g., one must be able to uniquely identify each occurrence of an entity with a primary key (e.g. Party Identifier, Account Identifier, Invoice Number, etc.). An Entity is typically named with a unique singular noun or noun phrase (e.g., PARTY, BILLING STATEMENT, etc.) that describes one occurrence of the Entity and cannot be used for any other Entity. It should be exclusive of every other Entity in the database. An Entity cannot appear more than once in the conceptual entity/relationship (E/R) model. Each Entity may have relationships to other Entities residing in its own Subject Area or in other Subject Areas.

### Attribute

An Attribute is a data fact about an Entity or Relationship. It is a logical (not physical) construct. It is data in its atomic form. In other words, it is the lowest level of information that still has business meaning without further decomposition. An example would be FIRST NAME, or LAST NAME. An example of an invalid attribute would be PERSON NAME if it includes both the first and last names, as this could be further decomposed into the separate, definable (first name, last name) data facts.

### Relationship

A Relationship is an association that links occurrences of one or more Entities. A Relationship must connect at least one Entity. If only one Entity is connected, the Relationship is said to be Recursive. A Relationship is described by a noun or passive verb or verb phase that describes the action taken in the Relationship. A Relationship represent a static state of being between the occurrences of the Entities it connects. Relationships are not intended to represent processes or data flows. They cannot be linked to another Relationships. They may optionally represent future, present, and/or past relatedness. The time frame must be explicitly defined in the data definition. Relationships may contain attributes. In a normalized model, a Relationship containing Attributes will result in the creation of an Entity.

### Cardinality

In order for a data model to be considered accurate, it must contain both the maximum and minimum number of Entity occurrences expected. This is controlled by rules of cardinality, which describes a relationship between two Entities based on how many occurrences of one Entity type may exist relative to the occurrence of the other Entity. Typically, it is a ratio, commonly depicted as a one-to-one (1:1); one-to-many (1:N); and many-to-many (M:N) relationship.

The maximum cardinality may be an infinite number or a fixed number but never zero. The minimum cardinality may be zero, or some other positive number, but it must be less than or equal to the maximum cardinality for the same relationship.

The logical data model for the E-Business will now be described in more detail. The logical data model uses IDEFIX modeling conventions, as shown in Table 1.

TABLE 1
Entity Conventions

| Convention | Definition |
|---|---|
| 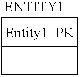 | Independent entity. An entity is depicted as a box, with its name above the box in singular, uppercase form. Square-boxed entities are independent. They rely on no other entity for their identification. Primary keys are attributes that uniquely identify the entity. Primary keys are shown at the top of the box, separated from other listed attributes by a horizontal line. |
| 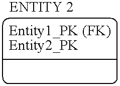 | Dependent entity. Round-cornered entities are dependent on one or more entities for their identification. (FK) following the primary key attribute indicates a foreign key—an attribute in the entity that is the primary key in another, closely related entity. |
| 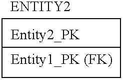 | An independent entity may also include a foreign key as a “non-primary key foreign key”. A non-primary key foreign key is shown below the horizontal line separating primary key attributes from other entity attributes. |

Relationship and cardinality conventions are shown in Table 2.

TABLE 2
Relationship/Cardinality Conventions

| Convention | Definition |
|---|---|
| 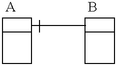 | A single line at the end of a relationship link means that a single record entity B is related to only one record in entity A . . . |
| 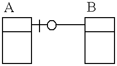 | A circle indicates that the presence of a linked record in entity A is optional. |
| 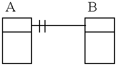 | A double line indicates that the presence of a linked record in entity A is mandatory. |
| 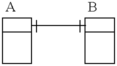 | One-to-one relationship. |
| 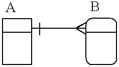 | One-to-many relationship. The crow's foot symbol means that more than one instance of an entity is associated with another entity. |
| 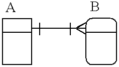 | One-to-one-or-many relationship. A crossbar with a crow's foot symbol means there is at least one instance of an entity associated with the other entity. |
| 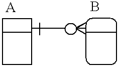 | One-to-zero-one-or-more relationship. A circle with a crow's feet symbol means there may be zero, one, or many instances of the entity associated with the other entity. |
| 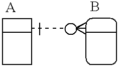 | A dotted relationship line indicates that the identity of entity B is not linked to entity A. |

### Retail Logical Data Model

The Retail Logical Data Model (rLDM) is a large data model composed of a large number of tables. To effectively view and understand the data model, the data tables have been logically organized into smaller groups called subject areas. Each subject area is comprised of a set of tables that contain information relevant to a particular entity. In addition, the subject areas address particular business questions.

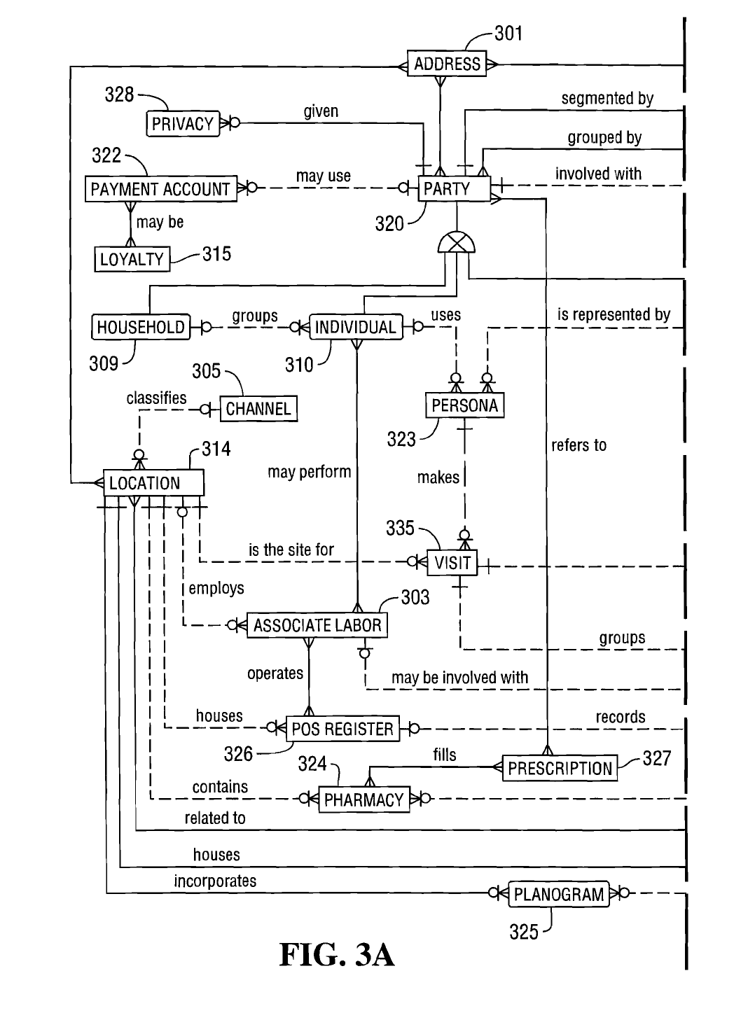

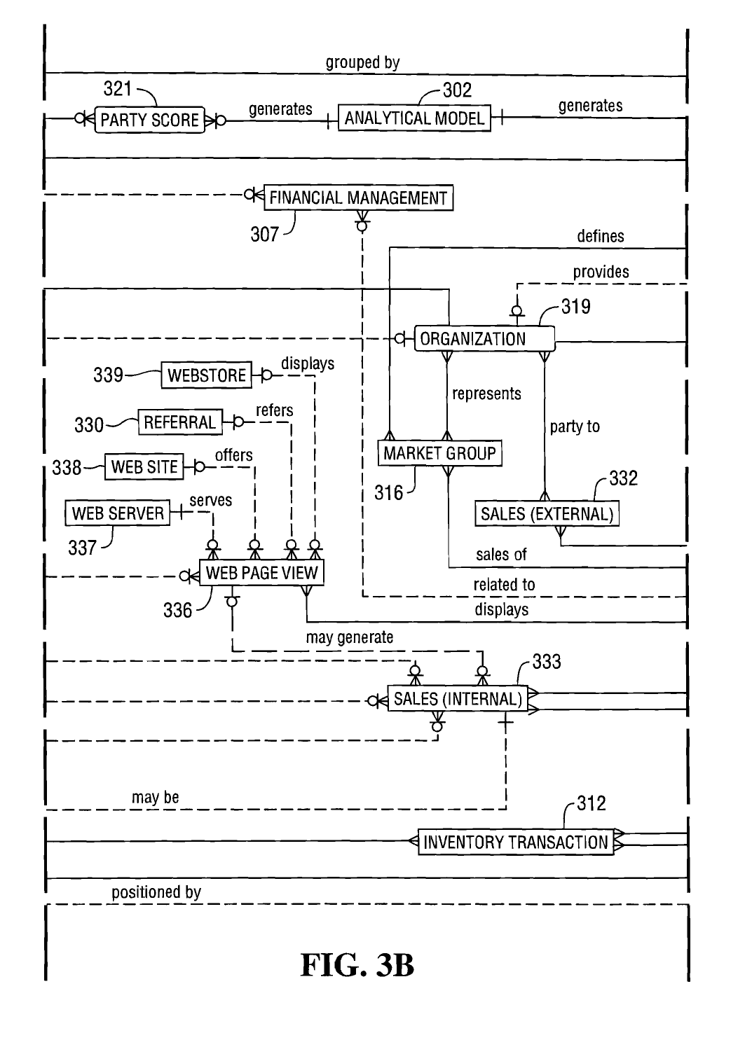

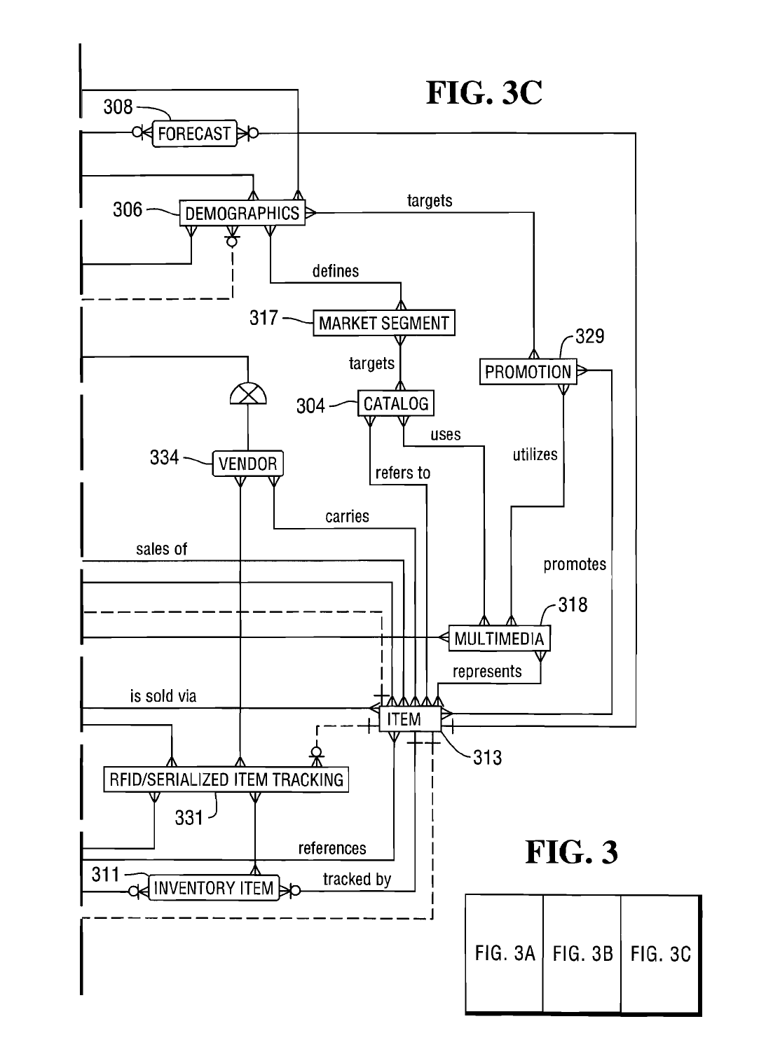

The Retail Logical Data Model is presented in the Conceptual View illustrated in FIGS. 3A through 3C. This view provides an overall high-level understanding of the major entities and how they relate to each other. The Conceptual View was derived directly from the Retail Logical Data Model by selecting the most important entities from every subject area, being sure that at least one entity from each subject area was selected, and distilling the relationships among the selected entities, while still maintaining the general nature of the way the entities relate to each other. During this process, some intervening entities were abstracted into relationships. Many-to-many relationships were used where appropriate. The result is a simple, easy to understand diagram that conveys the general content of the underlying logical data model.

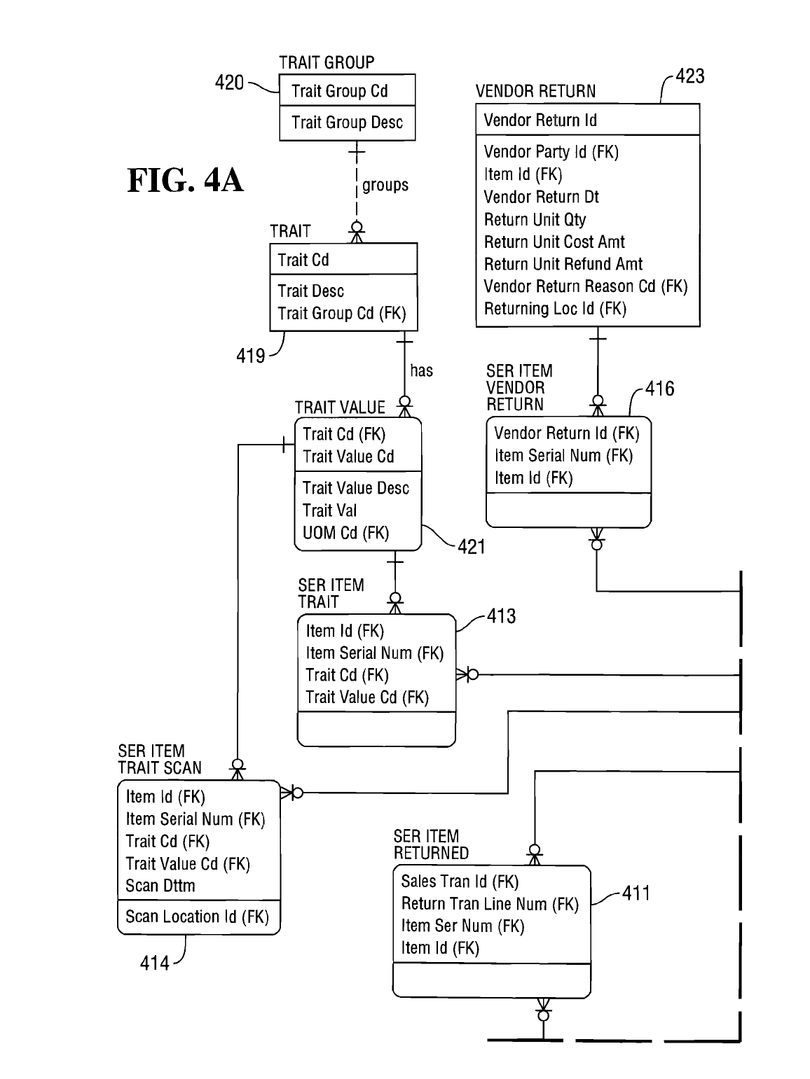

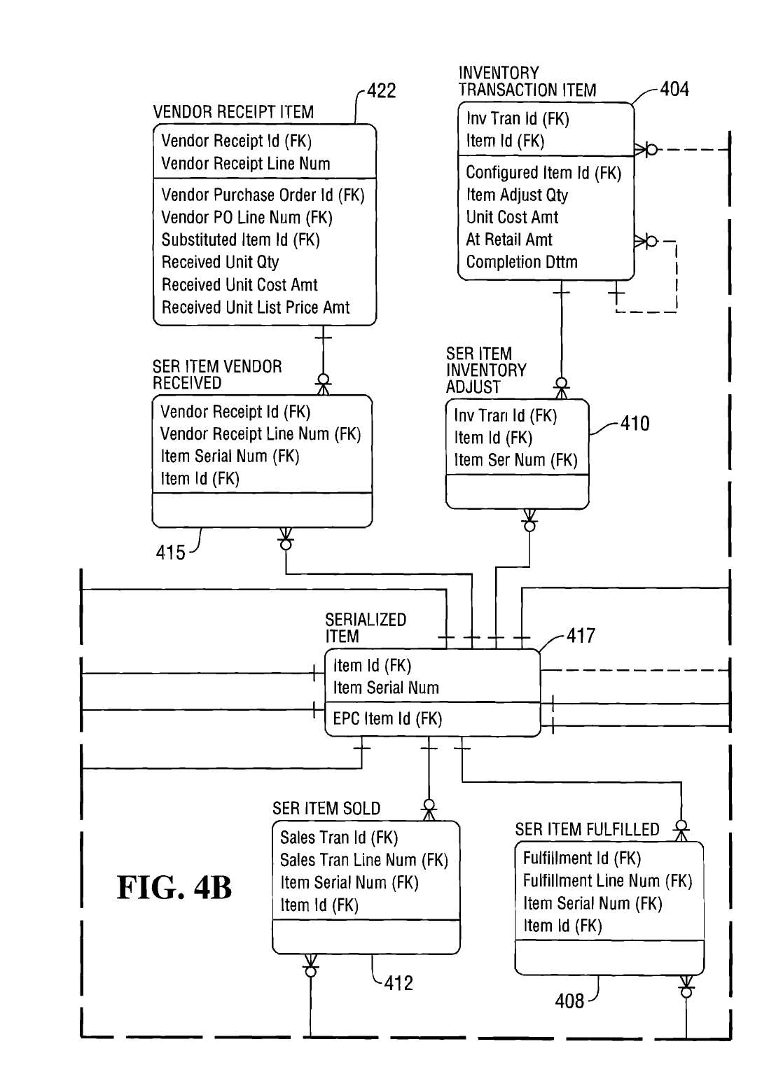

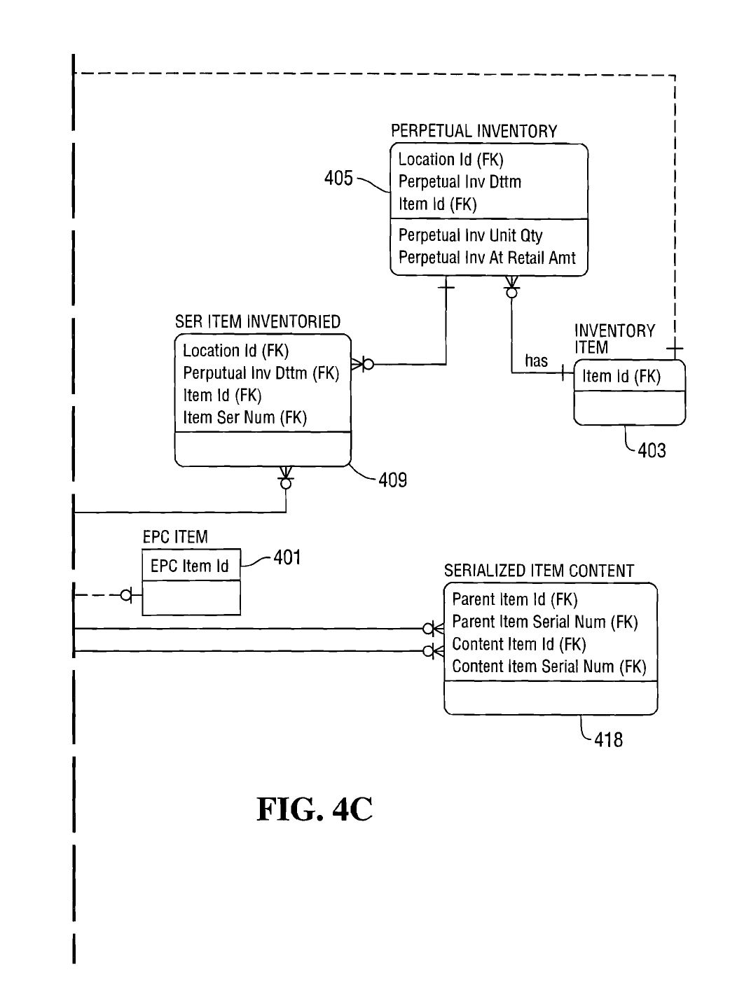

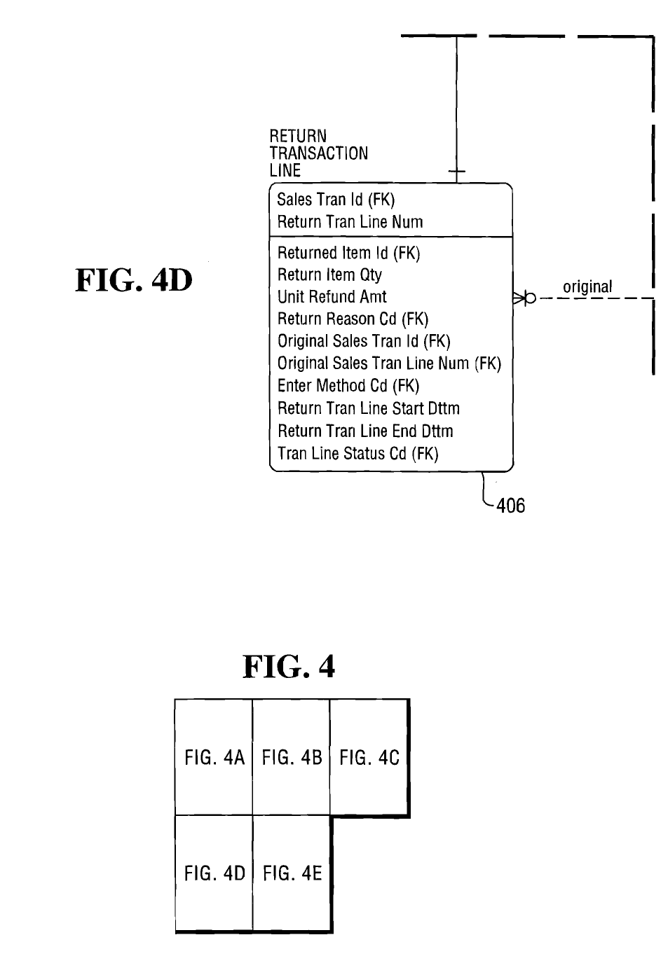

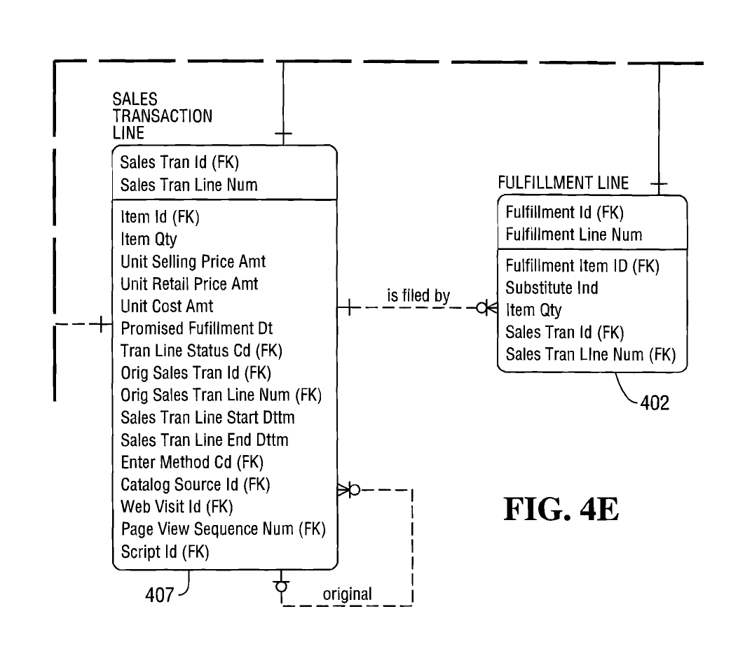

Subject Area Views, such as the RFID/SERIALIZED TRACKING subject area view illustrated in FIGS. 4A through 4E, show small (but highly detailed) subsets of the model. Subject areas are collections of entities about business information objects or concepts that are closely related. The sum total of all subject areas equals the rLDM. For ease of use and understanding, the Retail Logical Data Model has been divided into the following thirty-five (35) subject areas, titled:

1. ADDRESS,

2. ASSOCIATE LABOR,

3. CATALOG,

4. DEMOGRAPHICS,

5. FM.ASSET ACCOUNT,

6. FM.EQUITY ACCOUNT,

7. FM.EXPENSE ACCOUNT,

8. FM.GENERAL LEDGER ACCOUNT,

9. FM.CHART OF ACCOUNTS BALANCE,

10. FM.GL PRODUCT SEGMENT,

11. FM.GL PROJECT SEGMENT,

12. FM.GL SUB ACCOUNT SEGMENT,

13. FM.JOURMAL ENTRY,

14. FM.LIABILITY ACCOUNT,

15. FM.REVENUE ACCOUNT,

16. INVENTORY,

17. ITEM,

18. LOCATION,

19. MODEL SCORE and FORECAST,

20. MULTIMEDIA,

21. PARTY,

22. PAYMENT ACCOUNT,

23. PHARMACY,

24. PLANOGRAM,

25. POINT OF SALE REGISER,

26. PRIVACY,

27. PROMOTION,

28. RFID/SERIALIZED ITEM TRACKING,

29. SALES (EXTERNAL),

30. SALES (INTERNAL),

31. TIME PERIOD,

32. VENDOR,

33. WEB OPERATIONS,

34. WEB SITE, and

35. WEB VISIT.

Details about each of these subject areas follow.

The ADDRESS subject area, represented by ADDRESS entity 301 in the conceptual model of FIG. 3, is used to capture all ADDRESS information that can be used for communications and physical addressing. Each unique occurrence of an ADDRESS may represent a physical MAILING ADDRESS (e.g., street, post office box), a TELEPHONE ADDRESS (e.g., voice or fax number), or an ELECTRONIC ADDRESS (e.g., e-mail, ftp, or URL). Internet Protocol addresses are modeled separately in the entity IP ADDRESS within the WEB VISIT subject area.

The ASSOCIATE LABOR subject area, represented by ASSOCIATE LABOR entity 303 in FIG. 3, defines key business characteristics of an ASSOCIATE, sometimes referred to as an “employee” who, as an individual, is part of the internal organization of the Enterprise. The key emphasis of the ASSOCIATE LABOR subject area is to track the critical information necessary to understand, analyze and make better decisions regarding an Enterprise's labor costs and related labor expenses, as they relate to each ASSOCIATE.

This section models both the forecasted, or planned, labor for each location (stores, distribution and call centers, etc.) in cost amounts and hours (including overtime) and the schedule of work for each Associate. A history of expenses related to associate labor and benefits is provided to aid in comparison analyses.

The CATALOG subject area, represented by entity 304 in FIG. 3, is used to describe the content and usage of catalogs by an enterprise. The intent is to accommodate the typical printed catalog that is mass-mailed to a targeted/segmented group of potential customers. This Subject Area allows tracking of the success of a specific catalog or mailing, since it is related to the SALES (INTERNAL) Subject Area, indicating which sales were made from which catalog mailed to what target group.

Although targeted mainly at enterprises doing conventional catalog/mail order business, this section can be adapted for usage to also describe promotional flyers, and other printed offerings if required.

The pages of a Catalog may be either printed for mailing and physical distribution or may be “virtual” pages placed on a web site. Additional features are available on web sites such as keyword search and automated orders. This type of customer interaction is captured in the WEB VISIT subject area.

The DEMOGRAPHICS subject area is represented in FIG. 3 by DEMOGRAPHICS entity 306, MARKET GROUP entity 317 and MARKET SEGMENT entity 317. The DEMOGRAPHICS subject area contains information obtained (purchased/leased) from external sources. Its primary usage is for the creation of SEGMENTs (groups of PARTYs sharing common characteristics) for marketing purposes.

MARKET GROUPs record third party aggregated sales data, such as that purchased from Nielson or IRI, for example. Information about these groups (e.g., supermarket, category discounter, drug store, etc.) is typically purchased and often used by the Enterprise to measure its performance in the marketplace. Market Groups may also be associated with various DEMOGRAPHICs.

MARKET SEGMENTs are groups of PARTYs targeted by the Enterprise for marketing and/or analysis (and may be formed via algorithmic modeling or forecasting—See MODEL SCORE & FORECAST Subject Area). These segments are also related to DEMOGRAPHICs to enhance and support analysis and targeted sales campaigns (See PROMOTION Subject Area).

The eleven Financial Management (FM) subject areas; FM.ASSET ACCOUNT, FM.EQUITY ACCOUNT, FM.EXPENSE ACCOUNT, FM.GENERAL LEDGER ACCOUNT, FM.CHART OF ACCOUNTS BALANCE, FM.GL PRODUCT SEGMENT, FM.GL PROJECT SEGMENT, FM.GL SUB ACCOUNT SEGMENT, FM.JOURMAL ENTRY, FM.LIABILITY ACCOUNT, and FM.REVENUE ACCOUNT; are represented by a single entity, FINANCIAL MANAGEMENT entity 307 in FIG. 3.

The FM.ASSET ACCOUNT subject area contains information concerning enterprise assets. Assets are tangible or intangible property owned by a business, having monetary value (usually its cost or fair market value). These range from cash and investments to real estate such as land, other tangible property such as timber, or enforceable claims against others, etc. For accounting purposes these are usually classified under three groups: Current Assets, Fixed Assets and Other Assets. ASSET ACCOUNT refers to a type of General Ledger Account used to track the value of these assets.

The FM.EQUITY ACCOUNT subject area contains information concerning equity in an enterprise. Equity is the shareholders' stake in any company/business. From a financial accounting standpoint, Equity is total assets less total liabilities, also referred to as Net Worth or Stockholder's Equity.

The FM.EXPENSE ACCOUNT subject area contains information concerning enterprise expenses. Expense is the amount spent by a company in running the business and producing goods or services. Some of the typical expense accounts are OPERATING EXPENSE ACCOUNT, INTEREST EXPENSE ACCOUNT, etc.

The FM.GENERAL LEDGER ACCOUNT subject area contains information concerning an enterprise's General Ledger. The General Ledger is a collection of all accounts used by a business. It is the accounting transaction record, maintained either manually or using computer software, of all the balance sheet and income statement balances of a company or business. Previously as the name suggests, the General Ledger was a collection of books that was used to physically record accounting transactions. Today these transactions are generally recorded and stored by using computer software.

There are five main types of GENERAL LEDGER (GL) ACCOUNTs. They are ASSET ACCOUNT, LIABILITY ACCOUNT, EXPENSE ACCOUNT, REVENUE ACCOUNT and EQUITY ACCOUNT. Each account in turn may have sub-ledgers. For example, ASSET ACCOUNT consists of a group of accounts such as Fixed Asset Account, Current Asset Account, etc. The GL ACCOUNTs are shared by various internal organizations within a business and therefore are associated with other GL Segments in segment groups to track and report financial information.

The FM.GL CHART OF ACCOUNTS BALANCE subject area contains information concerning an enterprise's Chart of Account Balances. GL Chart of Accounts Balances are actual amounts experienced through some point in time, or budgeted amounts projected for a financial plan. Companies maintain only one record of actual amounts, but may define multiple financial plans and maintain balances for each financial plan instance.

GL Chart of Accounts Balance amounts are stored for defined groups of GL segments. GL segments—accounts, sub accounts, internal departments, products, projects, etc.—relate to areas of the business which the company wants to track. GL segments are identified by unique segment ids that are combined or concatenated into segment groups to represent a valid GL Chart of Accounts number. GL Chart of Account numbers will vary in number of segments and length from company to company, but each GL segment group should contain only 1 instance of each segment id. Companies define their own GL Chart of Account numbers and Chart of Accounts, or list of accounts tracked by their accounting system to capture the specific information required to meet the financial reporting needs of their business.

The FM.GL PRODUCT SEGMENT subject area is associated with GL Accounts in segment groups to track and report financial product information.

The FM.GL PROJECT SEGMENT subject area is associated with GL Accounts in segment groups to track and report financial project information. The GL PROJECT SEGMENT is used to track details of any type of business project activity.

The FM.GL SUB ACCOUNT SEGMENT subject area is associated with GL Accounts in segment groups to track and report financial transactions for a company.

The FM.JOURNAL ENTRY subject area contains information concerning an enterprise's Journal Entries. Journal Entries record the monetary value of business transactions into GL Accounts as debits or credits. Journal Entries usually include supporting information referencing the transaction events or items affected, such as a vendor invoice, customer invoice, or inventory receipt.

The FM.LIABILITY ACCOUNT subject area contains information concerning liabilities of an enterprise. The liabilities of a company are amounts owed to other parties or organizations representing loans, expenses, or any other form of a legally enforceable claim on the company's assets, excluding owner's equity that calls for the transfer of assets at a determined future date.

The FM REVENUE ACCOUNT subject area contains information concerning enterprise revenue. Revenue (sometimes referred to as income) refers to the amount of money earned by a company.

The INVENTORY subject area, represented in the conceptual model of FIG. 3 by INVENTORY ITEM entity 311 and INVENTORY TRANSACTION entity 312 details the movement of inventory between locations (facilities) as well as tracking physical and calculated stock levels and value, and provides for controlling in-stock and replenishment levels. Inventory is a company's merchandise, raw materials, and finished and unfinished products which have not yet been sold. Inventory can be individually valued by several different means, including cost or current market value, and collectively by FIFO (First in, first out), LIFO (Last in, first out) or other techniques.

The ITEM subject area, represented by ITEM entity 313 in FIG. 3 details all the ITEMs of interest to an enterprise. An ITEM is the lowest level for which inventory and sales records are retained within the retail store. It can be analogous to a SKU (Stock Keeping Unit).

The LOCATION subject area, represented by entities 314 and 305, LOCATION and CHANNEL, respectively, in FIG. 3, defines a physical or virtual site or facility which is owned or leased by a retailer to support the sale of goods, distribution, and storage. A LOCATION may be a WEB STORE, KIOSK, CALL CENTER, “brickand-mortar” STORE, PHARMACY, DISTRIBUTION CENTER, etc.

The MODEL, SCORE & FORECAST subject area supports functional areas such as:

(1) CUSTOMER RELATIONSHIP MANAGEMENT (CRM). By using Customer Scoring the Enterprise can tag their customers in a multitude of different ways to highlight their best customers for differentiated treatment. Example: Customers can be ‘scored’ for profitability, frequency of purchases, propensity to buy, etc. Vendors and suppliers may similarly be ‘scored’ on accuracy of orders, delivery time etc.

(2) DEMAND AND SUPPLY CHAIN MANAGEMENT. The various forecasting entities can be populated by the enterprise using their own statistical methods or by using the output of 3rd party applications. Since the model contains internally generated Sales and Order Forecasts, as well as Vendor generated Forecasts, these forecasts can be compared for possible deltas and exception reporting. And:

(3) KNOWLEDGE MANAGEMENT/DATA MINING. Supports information regarding the Analytical Models used to predict, cluster, or classify information that is typically used in Data Mining and Knowledge Discovery. Example: A Model that describes the propensity of a customer to buy a given item, etc.

The MODEL, SCORE & FORECAST subject area is represented in the conceptual model of FIG. 3 by ANALYTICAL MODEL entity 302, FORECAST entity 308, and PARTY SCORE entity 321.

This MULTMEDIA subject area, represented by entity 318 in FIG. 3, models the various multimedia elements that the enterprise uses to construct marketing collateral

The PARTY subject area defines the people and organizations of interest to an enterprise. This subject area is represented in the conceptual model by PARTY entity 320, HOUSEHOLD entity 309, INDIVIDUAL entity 310, ORGANIZATION entity 319, and PERSONA entity 323.

The PAYMENT ACCOUNT subject area, represented by PAYMENT ACCOUNT entity 322 and LOYALTY entity 315 in FIG. 3, describes the mechanism by which goods are be paid for, other than cash). Three main areas are described: conventional, typically external, payment accounts, such as credit cards, checking accounts, in-house credit cards, etc.; loyalty accounts comprising in-house programs designed to encourage customers to make purchases by offering rewards; and internal accounts such as Gift Cards, Gift Certificates, etc.

The PHARMACY subject area represents information about the dispensing and payment for prescription drugs, from the perspective of a Retail Pharmacy. This subject is represented in FIG. 3 by PHARMACY entity 324 and PRESCRIPTION entity 327.

The PLANOGRAM subject area, represented by entity 325 in FIG. 3, models information concerning where items are located in a store, as well as relationships to other items in their proximity.

This POINT OF SALE REGISTER subject area is represented by entity 326 in FIG. 3. This subject are is used to capture all non-sales related transactions involving P.O.S. Registers (Associate sign-in/out or No-Sale events, etc.) as well as specific sales transaction related keying sequence events (quantity key, price override). Application areas that can make use of this information could be, for example, cashier productivity, loss prevention, fraud detection or validation/auditing applications that reconcile data warehouse content with actual P.O.S. logs.

Two main areas are covered: Register events (POS SALES) taking place as part of a Sale (quantity key, price override, etc.), and those Register events (POS NON SALES) taking place independent of a Sales transaction (settlement, logging, etc.).

The detail information in this Subject Area is critical in tracking and identifying exceptions, suspicious or potentially fraudulent activities and for productivity and training plans and issues.

This PRIVACY subject area represents a PARTY's privacy settings for the collection and use of personal data. Privacy, and the control of one's personal data, is rapidly gaining attention in the media and political arena. Consumers are becoming more privacy-assertive; and with the rapid adoption of online privacy for the Web, offline privacy expectations are rising.

Privacy data fields are those which pertain to personal data, such as age, gender, income, marital status, or purchase habits;, reveal identity, such as name, address, phone number, social security number, bank account number; or “special categories” of data, such as racial or ethnic origin, religious beliefs, etc.

This PROMOTION subject area models the key information necessary to support the tracking and analysis of an enterprise's marketing efforts. It allows the determination of promotional effectiveness by tracking market segments or individuals targeted with promotional offers and the eventual response to the promotion in the form of Sales lift or Coupon redemption. This area also captures the promotion budget, actual promotion expenses and expected or planned sales revenue associated with a given promotion. The PROMOTION subject are is represented by entity 329 in FIG. 3.

The RFID/SERIALIZED ITEM TRACKING subject area provides a view of all aspects of Serialized Item tracking present in the model, supporting the use of RFID (Radio Frequency Identification) Technology in the retail industry.

The Subject Area, represented by entity 331 in FIG. 3 and shown in detail in FIG. 4, tracks the three different types of movement of Serialized Items: movement to and from suppliers, movement between internal locations, and movement to and from customers.

The SALES (EXTERNAL) subject area, represented by entity 332 in FIG. 3, details sales transactions reported by a third party, possibly from a Trading Partner or Purchased/leased information from a syndication organization such as VNU, IRI, Nielsen, etc. The enterprise is neither the selling nor purchasing party in any of these transactions.

Syndicated information is available at many different aggregation levels, but is typically grouped by MARKET GROUP, shown as entity 316 in FIG. 3, externally defined grouping of organizations that are part of the same sub-industry, such as supermarkets, convenience stores, drugstores, mass merchandisers, warehouse clubs, etc.

External sales information is used by an enterprise to measure market share and performance.

The SALES (INTERNAL) subject area, represented by entity 333 in FIG. 3, captures information concerning the sale and fulfillment of products and services offered by an enterprise. This subject area details what was sold to whom, who paid for it, how paid for, and when, how and by whom it was provided to the customer.

Sales transactions are grouped together at a VISIT level, shown as entity 335 in FIG. 3, defining all the sales related transactions made by a customer during a predefined time period at a given location.

The TIME PERIOD subject area, not shown, can be used to map country-specific holidays and events, climate and sales seasons. Additionally, it can be used to map into an enterprise's accounting and fiscal time periods.

The VENDOR subject area, represented by entity 334 in FIG. 3, captures information concerning the type of ORGANIZATION that supplies ITEMs to a retail company. This area models purchase orders made to the VENDOR and receipt of items in return.

The WEB OPERATIONS subject area models web server activity and web visit interactions. The central entity within the WEB OPERATIONS subject area is the WEB SERVER entity, identified by reference numeral 337 in FIG. 3. This subject area also models other areas associated with web site services. Such information as server capacity, software and activity provide for monitoring and maintenance are tracked.

All key aspects of an enterprise's web site(s); e.g., the content, intent, multimedia components, advertising, page navigation, etc.; are represented in the WEB SITE subject area. The WEB SITE subject area is represented in the conceptual model of FIG. 3 by WEB SITE entity 338 and WEB STORE entity 339.

The WEB VISIT subject area is represented by REFERRAL entity 330 and WEB PAGE VIEW entity 336 in FIG. 3. This subject area stores information about web visitors, visitor web activity and browsing history, and referrals.

More detailed information concerning the above described subject areas is available in Provisional Application Ser. No. 60/713,385, entitled “RFID/SERIALIZED ITEM TRACKING IN A RELATIONAL DATABASE SYSTEM,” filed on Sep. 1, 2005; Application Ser. No. 10/016,899, entitled “SYSTEM AND METHOD FOR CAPTURING AND STORING INFORMATION CONCERNING SHOPPERS INTERACTIONS AND TRANSACTIONS WITH AN E-BUSINESS RETAILER”, filed on Dec. 14, 2001, by Kim Nguyen-Hargett and Pieter Lessing; Application Ser. No. 10/017,146, entitled “SYSTEM AND METHOD FOR CAPTURING AND STORING INFORMATION CONCERNING RETAIL STORE OPERATIONS,” filed Dec. 14, 2001, by Kim Nguyen-Hargett and Pieter Lessing; and Application Ser. No. 10/190,099, entitled “SYSTEM AND METHOD FOR CAPTURING AND STORING FINANCIAL MANAGEMENT INFORMATION,” filed on Jul. 3, 2002 by Sreedhar Srikant, William S. Black, Scott Kilmo, Karen Papierniak and James W. Smith.

### RFID/Serialized Item Tracking Subject Area

The RFID/SERIALIZED ITEM TRACKING subject area, illustrated in FIGS. 4A through 4E, provides a view of all aspects of Serialized Item tracking present in the Retail Logical Data Model. The primary reason for creating this subject area and content is to support the use of RFID (Radio Frequency Identification) Technology in the retail industry.

The industry agreed standard of EPC (Electronic Product Code) provides a mechanism for tagging Serialized Items. The Electronic Product Code (EPC) is a unique number that identifies a specific item in the supply chain. The EPC is stored on a radio frequency identification (RFID) tag, which combines a silicon chip and an antenna. Once the EPC is retrieved from the tag, it can be associated with dynamic data, such as from where an item originated or the date of its production.

The entities of the RFID/SERIALIZED ITEM TRACKING subject area, illustrated in FIGS. 4A through 4E, are defined as follows:

EPC ITEM (401) This entity captures Serialized Items tagged with RFID Tags containing Electronic Product Codes. The Electronic Product Code (EPC) is a unique number that identifies a specific item in the supply chain. The EPC is stored on a radio frequency identification (RFID) tag, which combines a silicon chip and an antenna. Once the EPC is retrieved from the tag, it can be associated with dynamic data such as from where an item originated or the date of its production.

FULFILLMENT (402) The act of providing previously ordered or purchased ITEMs to a customer. It can be fulfilled by the enterprise or an external VENDOR and/or CARRIER (drop ship, etc.).

INVENTORY ITEM (403) A subset of items than can be inventoried, and shelved. This would exclude service items and virtual items (downloadable products).

INVENTORY TRANSACTION ITEM (404) Information about the item involved in an Inventory Transaction. Covers inventory transactions (adjustment of item counts) in locations belonging to the enterprise only. Examples include: transferring goods between distribution centers, supplying stores with goods from warehouse locations or distribution centers, adjusting inventory levels due to shrinkage, wastage or damage, etc. Note: The item quantity will be positive when adding to the inventory count (transfer in, etc.) and negative when subtracting from the inventory count (transfer out, wastage, etc.) Also, some transactions will create mirror pair entries in this entity.

PERPETUAL INVENTORY (405) Represents an up-to-date calculated inventory level status for a specific item within a specific location, for a specific date and time. PERPETUAL INVENTORY reflects all known inventory adjustments as they happen, providing a more real-time, up to date and time inventory position representation. The values represented by this entity are typically calculated by using the most recent inventory levels in the Item Inventory entity, and then applying all the transactions per item per location since that date (the transactions that should be taken into account include all the internal inventory transactions, and all transactions moving items from and to third parties (sales, vendor receipts, etc.).

RETURN TRANSACTION LINE (406) Details items returned to a location by a customer for a refund or an exchange.

SALES TRANSACTION LINE (407) The actual merchandise purchased by a customer during a transaction. An enterprise has alternatives of keeping lower level detail, where available, or of aggregating or “rolling up” like items. For example, the point of sale operator has the option to scan a single item and use the “quantity” key to indicate that eight of the same item were purchased, or the operator could separately scan each item. In the first case only a single line is produced by the point of sale terminal, while in the second case the terminal produces eight separate lines. During the load of the data warehouse the eight lines may be aggregated into a single line to reduce storage space, while at the same time losing visibility into the eight lines of detail data.

SER ITEM FULFILLED (408) Identifies the specific Serialized Items that were actually provided to a Customer. This tracking may be enabled via RFID Technology. Pharmacy Note: In the case of Pharmacy Items, this can be used to capture Batch/Lot information of the provided drugs.

SER ITEM INVENTORIED (409) Identifies the specific Serialized Items that are inventoried at a specific location.

SER ITEM INVENTORY ADJUST (410) Identifies the specific Serialized Items that were added or deleted from inventory at a specific internal location due to the internal movement of goods (no third party involved). The reason for the addition/deletion is detailed in the INVENTORY Subject Area.

SER ITEM RETURNED (411) Identifies the specific Serialized Items that were returned by a customer to an enterprise.

SER ITEM SOLD (412) Identifies the specific Serialized Items that were sold to a customer.

SER ITEM TRAIT (413) The actual value describing the specific TRAIT of a Serialized Item (a specific instance of an ITEM). A Serialized Item can have an unlimited number of Traits. Traits that may be captured for Serialized Items include expiration dates, manufacturing information, etc. For example, the item Canon IDs Digital Camera with Item Serial Num: 129384732 has the following Traits: Manufacture Date: Jun. 12, 2004, Plant Num: 2321, Inspected by: R. Sakamoto.

SER ITEM TRAIT SCAN (414) The primary use of this entity is to record the values of environmental traits of an Item as reported by a scanner/reader at a specific point in time. This entity is similar to SER ITEM TRAIT entity 413 mentioned above, in that it describes a trait or characteristic of a Serialized Item. However, the SER ITEM TRAIT SCAN entity records a dynamic trait that may only be true at a specific point in time, as opposed to the SER ITEM TRAIT entity that records static/permanent traits. Example: A sensor reads the ambient temperature and pressure of an item, and transmits the results every hour via RFID technology.

SER ITEM VENDOR RECEIVED (415) Identifies the specific Serialized Items that were received from a vendor.

SER ITEM VENDOR RETURN (416) Identifies the specific Serialized Items that were returned to the Vendor.

SERIALIZED ITEM (417) Allows the identification of specific instances of an item. Item instances can be uniquely identified in several ways, for example: an imbedded manufacturer serial number on the Item (cameras, dvd players, firearms, etc.), or a tag fixed to the item for tracking purposes (as in the case of RFID tags).

SERIALIZED ITEM CONTENT (418) Describes the ‘bill of material’ of an item than contains other items.

TRAIT (419) Describes a trait of an item, e.g., color, height, suitable age rating, etc.

TRAIT GROUP (420) A cluster of related item TRAITs. For example, ‘Size’ could be a TRAIT GROUP, with each of the dimensions (height, width, depth) being a separate TRAIT.

TRAIT VALUE (421) The actual value describing the specific TRAIT of a specific item. Example: Color=“blue”, Suitable Age rating=“‘b 12 years and older.”

VENDOR RECEIPT ITEM (422) Information about a specific item contained in a vendor receipt.

VENDOR RETURN (423) Items returned to a vendor, due to damage or malfunctioning of the ITEM.

A listing of all the attributes included within the entities shown in FIGS. 4A through 4E, together with a brief description of each attribute, is provided in Appendix A.

It should be noted that the RFID/SERIALIZED ITEM TRACKING subject area structure can be used to accommodate any implementation of Serialized Item tracking—it need not use RFID technology.

The RFID/SERIALIZED ITEM TRACKING subject area illustrated in FIG. 4 tracks the three different types of movement of Serialized Items: movement to and from suppliers (top left area of FIG. 4), movement between internal locations (top right area of FIG. 4), and movement to and from customers (bottom area or FIG. 4).

All of the Serialized Tracking entities also appear in other relevant subject areas, such as the ITEM, INVENTORY, SALES (INTERNAL), PHARMACY, and VENDOR subject areas described above.

The model represents the case of unique serial numbers for both the SERIALIZED ITEM entity and the EPC ITEM entity. If there is a need to represent non-unique serial numbers, a small adjustment would need to be made by adding a Quantity attribute to all Serialized Item instances—this quantity attribute is obviously not needed in the case of unique serial numbers—since the quantity for any serial number will always be 1.

### Conclusion

The Figures and description of the invention provided above reveal a flexible relational data model for a retail enterprise data warehouse solution. The data model design enables the capturing of serialized item tracking information for products sold by the retail enterprise. Maintaining this information in a data warehouse provides the retail enterprise with the ability to analyze and improve supply chain operations, to better manage store inventory, and more efficiently manage product sales and returns.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A logical data model for managing serialized item tracking information for a retail enterprise, the logical data model including:
a plurality of entities and relationships defining the manner in which serialized item tracking information associated with products sold by said retail enterprise is stored and organized within a relational database.

2. The logical data model in accordance with claim 1, wherein said serialized item tracking information comprises at least one information type selected from the group consisting of:
tracking information concerning movement of products between said retail enterprise and product suppliers;
tracking information concerning movement between internal locations of said retail enterprise; and
tracking information concerning movement of products between said retail enterprise and customers of said retail enterprise.

3. The logical data model in accordance with claim 1, wherein said serialized item tracking information is obtained utilizing RFID technology.

4. The logical data model in accordance with claim 1, wherein said products are tracked by electronic product codes (EPC) affixed to said products.

5. The logical data model in accordance with claim 4, wherein said electronic product codes (EPC) are encoded in RFID tags affixed to said products.

6. A relational database system for storing and managing serialized tracking information for a retail enterprise, said serialized tracking information being organized within said relational database system in accordance with a logical data model, said logical data model comprising:
a plurality of entities and relationships defining the manner in which serialized item tracking information associated with products sold by said retail enterprise is stored and organized within a relational database.

7. The relational database system in accordance with claim 6, wherein said serialized item tracking information comprises at least one information type selected from the group consisting of:
tracking information concerning movement of products between said retail enterprise and product suppliers;
tracking information concerning movement between internal locations of said retail enterprise; and
tracking information concerning movement of products between said retail enterprise and customers of said retail enterprise.

8. The relational database system in accordance with claim 6, wherein said serialized item tracking information is obtained utilizing RFID technology.

9. The relational database system in accordance with claim 6, further wherein said products are identified within said database system by electronic product codes (EPC) affixed to said products.

10. The relational database system in accordance with claim 9, wherein said electronic product codes (EPC) are encoded in RFID tags affixed to said products.

11. A method for storing and managing serialized tracking information for a retail enterprise, said method comprising the steps of:
establishing a relational database for storing and organizing serialized tracking information associated with products sold by said retail enterprise; and
establishing a logical data model including a plurality of entities and relationships defining the manner in which said serialized tracking information is stored and organized within said relational database.

12. The method in accordance with claim 11, wherein said serialized item tracking information comprises at least one information type selected from the group consisting of:
tracking information concerning movement of products between said retail enterprise and product suppliers;
tracking information concerning movement between internal locations of said retail enterprise; and
tracking information concerning movement of products between said retail enterprise and customers of said retail enterprise.

13. The method in accordance with claim 11, further comprising the step of:
identifying said products in said relational database by electronic product codes (EPC) affixed to said products.

14. The method in accordance with claim 13, wherein said electronic product codes (EPC) are encoded in RFID tags affixed to said products; said method further comprising the step of:
obtaining said serialized item tracking information from said products utilizing RFID technology.
